(19) United States
(12) Patent Application Publication
(10) Pub. No.: US 2016/0239808 A1
(43) Pub. Date: Aug. 18, 2016

(54) METHOD, SYSTEM, AND NON-TRANSITORY COMPUTER-READABLE RECORDING MEDIUM FOR PROVIDING RECOMMENDATIONS ON EVENT

(71) Applicant: KONOLABS, INC., Seoul (KR)

(72) Inventors: Jung Hee RYU, Seoul (KR); Joon Hee Kim, Seongnam (KR)

(21) Appl. No.: 14/874,516

(22) Filed: Oct. 5, 2015

(30) Foreign Application Priority Data
Feb. 16, 2015 (KR) 10-2015-0023619
Jul. 24, 2015 (KR) 10-2015-0105089

(51) Int. Cl. G06Q 10/10; G06Q 30/06

(52) U.S. Cl. CPC G06Q 10/1093; G06Q 30/0631

(57) ABSTRACT

According to one aspect of the present invention, there is provided a method for providing recommendations on an event, comprising the steps of: selecting at least one candidate for empty time slots common to a first user's schedule and a second user's schedule, in view of empty time slots in the first user's schedule and those in the second user's schedule; verifying the validity of the at least one common empty time slot candidate, based on information on an expected location of the first user and that of the second user associated with the at least one common empty slot candidate; and determining at least one event to be recommended to at least one of the first and second users for the common empty time slot candidate whose validity has been verified, based on at least one of context information of the first user and that of the second user.

### CROSS-REFERENCE TO RELATED APPLICATION

This application claims priority to and the benefit of Korean Patent Application No. 10-2015-0023619 filed in the Korean Intellectual Property Office on Feb. 16, 2015 and Korean Patent Application No. 10-2015-0105089 filed in the Korean Intellectual Property Office on Jul. 24, 2015, the entire contents of which are incorporated herein by reference.

### BACKGROUND OF THE INVENTION

(a) Field of the Invention

The present invention relates to a method, system, and non-transitory computer-readable recording medium for providing recommendations on an event.

(b) Description of the Related Art

In order to create a new event in conventional calendar programs (or applications), a user should personally find an empty time slot on a timetable, and manually enter specific information on the event one by one, such as a task, location, start time, end time, recurrence, upcoming event notification generation time, etc. For this reason, a problem occurs in that it takes a great deal of time and effort for the user to manage schedule. Although there are various calendar programs that have been recently developed, these programs simply differ in terms of exterior elements such as designs or titles, and basically have the same problems as above.

Further, the conventional calendar programs only provide schedule management functionality for a single user, and thus, when managing an event involving two or more users, the users cannot avoid the inconvenience of personally contacting each user, separately from the calendar programs to discuss a time or location of the event, and entering information on the decided time or location of the event into the calendar programs, one by one.

Meanwhile, in order to address the aforementioned drawbacks of the conventional calendar programs, some programs have been introduced to support easy management of to-do lists. These to-do list management programs may function to allow a user to conveniently enter and organize tasks and to check the completion of the tasks. However, these programs do not take into account respective task durations or other events included in the user's schedule, and are not, therefore, suitable to be used as programs for generally managing the user's schedule.

In this connection, the present inventor(s) propose a technique for automatically recommending an event or location for a common empty time slot verified as valid among common empty time slots in two or more users' schedules.

The above information disclosed in this Background section is only for enhancement of understanding of the background of the invention and therefore it may contain information that does not form the prior art that is already known in this country to a person of ordinary skill in the art.

### SUMMARY OF THE INVENTION

One object of the present invention is to solve all of the above-described problems in prior art.

Another object of the present invention is to automatically recommend an event or location for a common empty time slot verified as valid among common empty time slots in two or more users' schedules, by selecting at least one candidate for empty time slots common to a first user and a second user, in view of empty time slots in the first user's schedule and those in the second user's schedule, verifying the validity of the at least one common empty time slot candidate, based on information on an expected location of the first user and that of the second user associated with the at least one common empty slot candidate, and determining at least one event to be recommended to the first or second user for the common empty time slot candidate whose validity has been verified, based on at least one of context information of the first user and that of the second user.

The representative configurations of the present invention for achieving the above-described objects are as follows.

According to one aspect of the present invention, there is provided a method for providing recommendations on an event, comprising the steps of: selecting at least one candidate for empty time slots common to a first users schedule and a second user's schedule, in view of empty time slots in the first user's schedule and those in the second user's schedule; verifying the validity of the at least one common empty time slot candidate, based on information on an expected location of the first user and that of the second user associated with the at least one common empty slot candidate; and determining at least one event to be recommended to at least one of the first and second users for the common empty time slot candidate whose validity has been verified, based on at least one of context information of the first user and that of the second user.

According to another aspect of the present invention, there is provided a method for providing recommendations on an event, comprising the steps of: selecting at least one candidate for empty time slots common to a first users schedule and a second user's schedule, in view of empty time slots in the first user's schedule and those in the second user's schedule; verifying the validity of the at least one common empty time slot candidate, based on information on an expected location of the first user and that of the second user associated with the at least one common empty slot candidate; and determining at least one location to be recommended to at least one of the first and second users for the common empty time slot candidate whose validity has been verified, based on at least one of context information of the first user and that of the second user.

According to yet another aspect of the present invention, there is provided a system for providing recommendations on an event, comprising: a common empty time slot verification unit for selecting at least one candidate for empty time slots common to a first user's schedule and a second user's schedule, in view of empty time slots in the first user's schedule and those in the second user's schedule, and verifying the validity of the at least one common empty time slot candidate, based on information on an expected location of the first user and that of the second user associated with the at least one common empty slot candidate; and a recommendation provision unit for determining at least one event to be recommended to at least one of the first and second users for the common empty time slot candidate whose validity has been verified, based on at least one of context information of the first user and that of the second user.

According to still another aspect of the present invention, there is provided a system for providing recommendations on an event, comprising: a common empty time slot verification unit for selecting at least one candidate for empty time slots common to a first user's schedule and a second user's schedule, in view of empty time slots in the first user's schedule and those in the second user's schedule, and verifying the validity of the at least one common empty time slot candidate, based on information on an expected location of the first user and that of the second user associated with the at least one common empty slot candidate; and a recommendation provision unit for determining at least one location to be recommended to at least one of the first and second users for the common empty time slot candidate whose validity has been verified, based on at least one of context information of the first user and that of the second user.

In addition, there are further provided other methods and systems for implementing the present invention, as well as non-transitory computer-readable recording media for storing computer programs for executing the above methods.

According to the present invention, it is possible to effectively recommend an event in which two or more users can participate together or a location suitable for this event, by automatically determining an event or location suitable for an empty time slot which is common to schedules of the two or more users and verified as valid, and actively recommending the event or location to the users.

According to the present invention, an event or location to be recommended to a user may be automatically determined and presented to the user, even if the user does not voluntarily take a specific action to create a new event in the user's schedule.

### BRIEF DESCRIPTION OF THE DRAWINGS

FIG. 1 schematically shows the configuration of an overall system for providing recommendations on an event according to one embodiment of the present invention.

FIG. 2 illustratively shows the internal configuration of a service provision system according to one embodiment of the present invention.

FIG. 3 illustratively shows a procedure of providing recommendations on an event according to one embodiment of the present invention.

### DETAILED DESCRIPTION OF THE EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the locations or arrangements of individual components within each of the disclosed embodiments may also be modified without departing from the spirit and scope of the invention. Therefore, the following detailed description is not to be taken in a limiting sense, and the scope of the invention, if properly described, is limited only by the appended claims and all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of Overall System

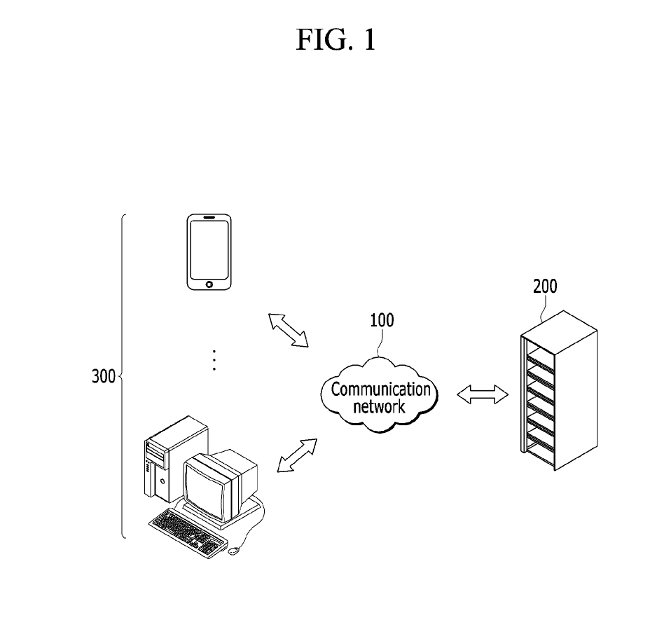

FIG. 1 schematically shows the configuration of an overall system for providing recommendations on an event according to one embodiment of the present invention.

As illustrated in FIG. 1, the overall system according to one embodiment of the present invention may include a communication network 100, a service provision system 200, and user terminal devices 300.

First, the communication network 100 according to one embodiment of the present invention may be configured regardless of communication modality such as wired and wireless communications, and may be configured as a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include a well-known wired/wireless data communication network, a well-known telephone network, or a well-known wired/wireless television communication network.

Next, the service provision system 200 according to one embodiment of the present invention may function to automatically recommend an event or location for a common empty time slot verified as valid among common empty time slots in two or more users' schedules, by selecting at least one candidate for empty time slots common to a first user and a second user, in view of empty time slots in the first user's schedule and those in the second user's schedule, verifying the validity of the at least one common empty time slot candidate, based on information on an expected location of the first user and that of the second user associated with the at least one common empty slot candidate, and determining at least one event to be recommended to the first or second user for the common empty time slot candidate whose validity has been verified, based on at least one of context information of the first user and that of the second user.

The configuration and function of the service provision system 200 according to the present invention will be discussed in detail in the following detailed description.

The user terminal device 300 according to one embodiment of the present invention is digital equipment capable of allowing a user to connect to and communicate with the service provision system 200. Any digital equipment may be employed as the user terminal device 300 according to the present invention as long as it has a memory means and a microprocessor for computing capabilities, like smartphones, tablets, desktop computers, laptops, workstations, PDAs, web pads, mobile phones, etc.

Particularly, the user terminal device 300 may include an application (not shown) that supports the provision of services to the user from the service provision system 200. This application may be downloaded from the service provision system 200 or a well-known web server (not shown). Obviously, the application may be provided by implementing a calendar GUI for a conventional calendar program (e.g., a calendar GUI for schedule management in Microsoft Outlook), as necessary. At least part of the information for configuring such a calendar GUI may be received from the service provision system 200.

Configuration of Service Provision System

Hereinafter, the internal configuration of the service provision system 200 crucial for implementing the present invention and the functions of the respective components thereof will be discussed.

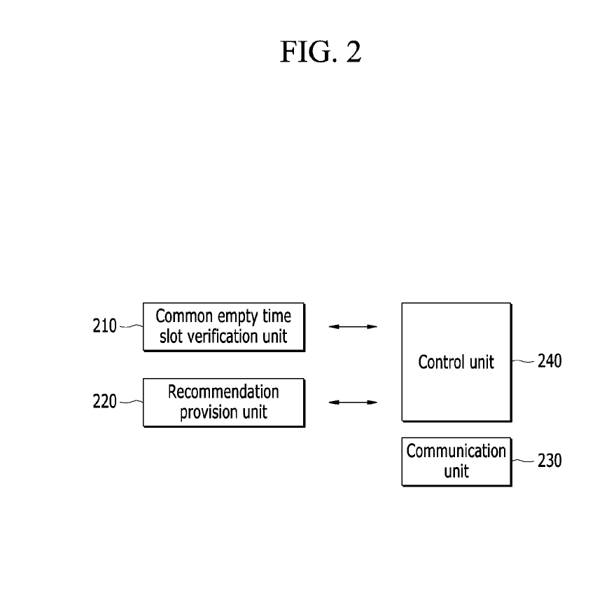

FIG. 2 illustratively shows the internal configuration of a service provision system according to one embodiment of the present invention.

Referring to FIG. 2, the service provision system 200 according to one embodiment of the present invention may include a common empty time slot verification unit 210, a recommendation provision unit 220, a communication unit 230, and a control unit 240. According to one embodiment of the present invention, at least some of the common empty time slot verification unit 210, the recommendation provision unit 220, the communication unit 230, and the control unit 240 may be program modules that communicate with an external system (not shown). The program modules may be included in the service provision system 200 in the form of operating systems, application program modules, or other program modules. Physically, they may be stored in various well-known storage devices. Further, the program modules may also be stored in a remote storage device capable of communicating with the service provision system 200. These program modules may include, but are not limited to, routines, subroutines, programs, objects, components, data structures, etc. for performing specific tasks or executing specific abstract data types to be described later in accordance with the invention.

First, according to one embodiment of the present invention, the common empty time slot verification unit 210 may function to select at least one candidate for empty time slots common to a first user' schedule and a second user's schedule, in view of empty time slots in the first user's schedule and those in the second user's schedule.

For example, it is assumed that candidates for common empty time slots are selected from the schedule of a first user who is to stay only in Seoul during the period from Jul. 1, 2015 to Jul. 31, 2015 and that of a second user who is to stay in Seoul and then visit New York during the same period. In this case, the common empty time slot verification unit 210 according to one embodiment of the present invention may select morning hours of Jul. 2, 2015, afternoon hours of Jul. 7, 2015, and evening hours of Jul. 24, 2015, in which no events are determined to exist in both the schedules of the first and second users, as the candidates for the common empty time slots.

According to one embodiment of the present invention, the common empty time slot verification unit 210 may function to verify the validity of the common empty time slot candidates, based on information on an expected location of the first user and that of the second user associated with the at least one common empty slot candidate selected as above.

Here, the expected location of the first or second user may be a location at which the first or second user is expected to be at a point of time within a predetermined period of time from the common empty time slot candidate whose validity is to be verified. The point of time may include an end time or start time of another event scheduled immediately before or after the common empty time slot candidate whose validity is to be verified in the schedule of the first or second user.

Also, according to one embodiment of the present invention, the expected location of the first or second user may be determined based on information on locations obtained from the user terminal device 300 carried by the first or second user, information on the first or second user's activities on social network services (SNS), information on the first or second user's translocation history, and so on.

Specifically, the common empty time slot verification unit 210 according to one embodiment of the present invention may verify as valid the common empty time slot candidates determined to enable the first and second users to meet in person, among the at least one common empty time slot candidate selected as above, in view of both the expected locations of the first and second users.

Also, the common empty time slot verification unit 210 according to one embodiment of the present invention may verify as valid the common empty time slot candidate determined to enable a distance or time required for the first or second user to travel from the first or second user's expected location to meet the second or first user in person to be equal to or less than a predetermined level, among the at least one common empty time slot candidate selected as above.

For example, it is assumed that three candidates for common empty time slots, that is, morning hours of Jul. 2, 2015, afternoon hours of Jul. 7, 2015, and evening hours of Jul. 24, 2015 are selected from the schedule of a first user who is to stay only in Seoul during the period from Jul. 1, 2015 to Jul. 31, 2015 and that of a second user who is to stay in Seoul and then visit New York during the same period. In this case, the common empty time slot verification unit 210 according to one embodiment of the present invention may verify the morning hours of Jul. 2, 2015 and the afternoon hours of Jul. 7, 2015, in which both the first and second users are expected to be in Seoul, as the valid common empty time slot candidates, or may verify only the afternoon hours of Jul. 7, 2015, in which both the first and second users are expected to be in Seoul and a time required for the first or second user to travel to meet the second or first user in person is expected to be less than 1 hour, as the valid common empty time slot candidate.

Meanwhile, the recommendation provision unit 220 according to one embodiment of the present invention may function to determine at least one event to be recommended to the first or second user for the common empty time slot candidate whose validity has been verified, based on at least one of context information of the first user and that of the second user.

Moreover, according to one embodiment of the present invention, the recommendation provision unit 220 may function to determine at least one location to be recommended to the first or second user for the common empty time slot candidate whose validity has been verified, based on at least one of context information of the first user and that of the second user, as well as to determine the events to be recommended to the first or second user. As such, according to the present invention, the first and second users may personally discuss and create an event as appropriate, based on the locations recommended as above.

Specifically, the recommendation provision unit 220 according to one embodiment of the present invention may search for and obtain the first or second user's context information on the common empty time slot candidate whose validity has been verified, from various information provided through online or offline services including social network services (SNS), as well as information provided through well-known websites. Here, the search is not limited only to the traditional concept of finding information directly matching a given keyword, but should be understood as the broadest concept even encompassing extraction or collection of information significantly associated with the common empty time slot candidate whose validity has been verified, even if the information does not directly match the keyword.

More specifically, according to one embodiment of the present invention, the context information of the first or second user may include information on a title, time, location, or other participating users of another event scheduled immediately before or after the common empty time slot candidate whose validity has been verified in the schedule of the first or second user, demographic information of the first or second user, information on time slots preferred by the first or second user, information on locations preferred by the first or second user, information on the first or second user's activities on social network services (SNS), information on chats the first or second user has had with other users, information on the first or second user's to-do list, information on the first or second user's memos, information on the relationship between the first and second users, information on the first or second user's event history, and so on. However, it should be noted that the context information described herein is not necessarily limited to those listed above, and that any other information may be used as the context information as long as the objects of the invention may be achieved.

For example, it is assumed that, during the period from Jul. 1, 2015 to Jul. 31, 2015, afternoon hours of Jul. 7, 2015 is the common empty time slot candidate whose validity has been verified in the schedules of the first and second users. In this case, the recommendation provision unit 230 according to one embodiment of the present invention may provide the first or second user with event recommendation information implying that it is advisable for the first and the second users to get a massage together at a massage shop ‘A’ located midway between the expected locations of the first and second users in the afternoon hours (more specifically, 2 pm) of Jul. 7, 2015, which is the common empty time slot candidate whose validity has been verified, with reference to context information that a business meeting is scheduled in morning hours of Jul. 7, 2015 on each of the schedules of the first and second users, so that the first and second users may relieve their stress to be caused by the business meeting.

For another example, the recommendation provision unit 220 according to one embodiment of the present invention may provide the first or second user with event recommendation information implying that it is advisable for the first and second users to have a business meeting at a place close to the first user's expected location in the afternoon hours (more specifically, 2 pm) of Jul. 7, 2015, which is the common empty time slot candidate whose validity has been verified, with reference to context information that the second user frequently visits the first user because the first user is senior to the second user in their social relationship (i.e., the first and second users are in a so-called senior-junior relationship), or that the first user has less mobility than the second user, so that the first user's travel distance or time may be minimized.

For yet another example, the recommendation provision unit 220 according to one embodiment of the present invention may provide the first or second user with event recommendation information implying that it is advisable to determine an event start time to be 15 minutes after when the first user is expected to arrive at an event location from the first user's expected location in the afternoon hours of Jul. 7, 2015, which is the common empty time slot candidate whose validity has been verified, with reference to context information that the first user has been usually late for the events the first user has previously attended by around 15 minutes on average.

For still another example, the recommendation provision unit 220 according to one embodiment of the present invention may provide the first or second user with location recommendation information including a list of Starbucks stores located within 5 km from the first or second user's expected location in the afternoon hours of Jul. 7, 2015, which is the common empty time slot candidate whose validity has been verified, with reference to context information that both the first and second users prefer Starbucks stores. Accordingly, the first and second users may discuss and determine a specific event location and event time based on the list of Starbucks stores provided as above.

It is to be noted that, in the foregoing embodiments, a well-known artificial intelligence algorithm may be used to determine an event or location to be recommended to the first or second user, and that the present invention is not limited to any particular artificial intelligence algorithm and a variety of artificial intelligence algorithms may be used as long as the objects of the invention may be achieved.

Meanwhile, the communication unit 230 according to one embodiment of the present invention functions to allow the service provision system 200 to communicate with an external device such as the user terminal device 300.

Lastly, the control unit 240 according to one embodiment of the present invention functions to control the flow of data among the common empty time slot verification unit 210, the recommendation provision unit 220, and the communication unit 230. That is, the control unit 240 controls inbound data flow or data flow among the respective components of the service provision system 200 such that the common empty time slot verification unit 210, the recommendation provision unit 220, and the communication unit 230 carry out their particular functions, respectively.

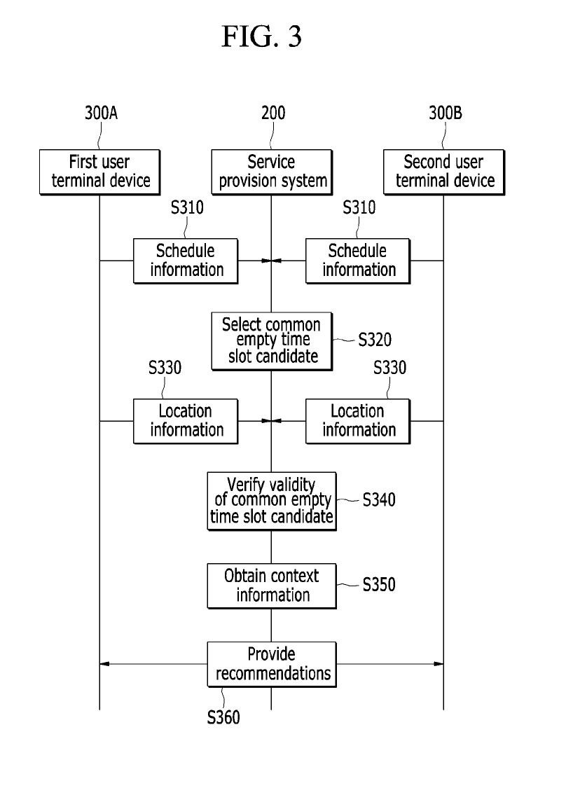

FIG. 3 illustratively shows a procedure of providing recommendations on an event according to one embodiment of the present invention.

Referring to FIG. 3, the service provision system 200 according to one embodiment of the present invention may obtain schedule information from the first user's terminal device 300A and the second user's terminal device 300B (or from other user terminal devices (not shown), an external server (not shown), or the like) (S310), and select candidates for empty time slots common to the schedules of the first and second users (S320). Next, referring to FIG. 3, the service provision system 200 according to one embodiment of the present invention may obtain information on the expected locations of the first and second users (S330), and verify the validity of the common empty time slot candidates (S340). Following this, referring to FIG. 3, the service provision system 200 according to one embodiment of the present invention may obtain context information on the common empty time slot candidates whose validity has been verified (S350), and determine an event or location to be recommended to the first or second user (S360).

However, it should be noted that the procedure of providing recommendations on an event according to the present invention is not necessarily limited to the embodiment of FIG. 3, and that the procedure can be changed without limitation as long as the objects of the invention may be achieved. For example, the schedule information or location information of the first or second user may be obtained not only from the terminal devices 300A, 300B of the first and second users, but also from terminal devices of other users (not shown) or an external server (not shown).

Although the embodiments for providing recommendations to create a new event have been mainly described above, the present invention is not necessarily limited to the above embodiments. It should be noted that any embodiments for providing recommendations to modify or delete an event already existing in the first or second user's schedule (e.g., embodiments for adding, modifying, or deleting event configuration information such as an event type, event title, event time, event location, or other users to participate together) are also possible.

The embodiments according to the present invention described above may be implemented in the form of program instructions that can be executed by various computer components, and may be stored on a non-transitory computer-readable recording medium. The non-transitory computer-readable recording medium may include program instructions, data files, data structures, and the like individually or in combination. The program instructions stored on the non-transitory computer-readable recording medium may be specifically designed and configured for the present invention, or may also be known and available to those skilled in the computer software field. Examples of the non-transitory computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

In the foregoing discussion, although the present invention has been described in connection with specific matters such as detailed components as well as the limited embodiments and the drawings, they are only provided to help more general understanding of the present invention, and the present invention is not limited to the above embodiments. It will be appreciated by those skilled in the art that various modifications and changes may be made from the above description.

Therefore, the spirit of the present invention should not be limited to the above-described embodiments, and the entire scope of the appended claims and their equivalents will be considered to fall within the scope and spirit of the present invention.

What is claimed is:

1. A method for providing recommendations on an event, comprising the steps of:
selecting at least one candidate for empty time slots common to a first user's schedule and a second user's schedule, in view of empty time slots in the first user's schedule and those in the second user's schedule;
verifying the validity of the at least one common empty time slot candidate, based on information on an expected location of the first user and that of the second user associated with the at least one common empty slot candidate; and
determining at least one event to be recommended to at least one of the first and second users for the common empty time slot candidate whose validity has been verified, based on at least one of context information of the first user and that of the second user.

2. The method of claim 1, wherein information on the expected locations of the first and second users comprises information on locations at which the first and second users are respectively expected to be at a point of time within a predetermined period of time from the common empty time slot candidate whose validity is to be verified.

3. The method of claim 2, wherein the point of time comprises an end time of an event scheduled before the common empty time slot candidate whose validity is to be verified, or a start time of an event scheduled after the common empty time slot candidate whose validity is to be verified, in the schedule of the first or second user.

4. The method of claim 1, wherein the expected locations are determined based on at least one of information on locations obtained from a user terminal device carried by the first or second user, information on the first or second user's activities on social network services (SNS), and information on the first or second user's translocation history.

5. The method of claim 1, wherein the common empty time slot candidate whose validity has been verified comprises a common empty time slot candidate determined to enable the first and second users to meet in person.

6. The method of claim 1, wherein the common empty time slot candidate whose validity has been verified comprises a common empty time slot candidate determined to enable a distance or time required for the first or second user to travel from the first or second user's expected location to meet the second or first user in person to be equal to or less than a predetermined level.

7. The method of claim 1, wherein the step of providing recommendations comprises obtaining at least one of the context information of the first user and that of the second user, on the common empty time slot candidate whose validity has been verified.

8. The method of claim 1, wherein the context information comprises at least one of information on a title, time, location, or other participating users of another event scheduled before or after the common empty time slot candidate whose validity has been verified, in the schedule of the first or second user, demographic information of the first or second user, information on time slots preferred by the first or second user, information on locations preferred by the first or second user, information on the first or second user's activities on social network services (SNS), information on chats the first or second user has had with other users, information on the first or second user's to-do list, information on the first or second user's memos, information on the relationship between the first and second users, and information on the first or second user's event history.

9. A method for providing recommendations on an even, comprising the steps of:
selecting at least one candidate for empty time slots common to a first user's schedule and a second user's schedule, in view of empty time slots in the first user's schedule and those in the second user's schedule;
verifying the validity of the at least one common empty time slot candidate, based on information on an expected location of the first user and that of the second user associated with the at least one common empty slot candidate; and
determining at least one location to be recommended to at least one of the first and second users for the common empty time slot candidate whose validity has been verified, based on at least one of context information of the first user and that of the second user.

10. A non-transitory computer-readable recording medium for storing a computer program for executing the method of claim 1.

11. A system for providing recommendations on an event, comprising:
a common empty time slot verification unit for selecting at least one candidate for empty time slots common to a first user's schedule and a second user's schedule, in view of empty time slots in the first user's schedule and those in the second user's schedule, and verifying the validity of the at least one common empty time slot candidate, based on information on an expected location of the first user and that of the second user associated with the at least one common empty slot candidate; and
a recommendation provision unit for determining at least one event to be recommended to at least one of the first and second users for the common empty time slot candidate whose validity has been verified, based on at least one of context information of the first user and that of the second user.

12. The system of claim 11, wherein the expected locations are determined based on at least one of information on locations obtained from a user terminal device carried by the first or second user, information on the first or second user's activities on social network services (SNS), and information on the first or second user's translocation history.

13. The system of claim 11, wherein the common empty time slot candidate whose validity has been verified comprises a common empty time slot candidate determined to enable the first and second users to meet in person.

14. The system of claim 11, wherein the common empty time slot candidate whose validity has been verified comprises a common empty time slot candidate determined to enable a distance or time required for the first or second user to travel from the first or second user's expected location to meet the second or first user in person to be equal to or less than a predetermined level.

15. A system for providing recommendations on an event, comprising:
a common empty time slot verification unit for selecting at least one candidate for empty time slots common to a first user's schedule and a second user's schedule, in view of empty time slots in the first user's schedule and those in the second user's schedule, and verifying the validity of the at least one common empty time slot candidate, based on information on an expected location of the first user and that of the second user associated with the at least one common empty slot candidate; and
a recommendation provision unit for determining at least one location to be recommended to at least one of the first and second users for the common empty time slot candidate whose validity has been verified, based on at least one of context information of the first user and that of the second user.
